(19) United States
(12) Patent Application Publication
(10) Pub. No.: US 2024/0270289 A1
(43) Pub. Date: Aug. 15, 2024

(54) Modular High-Speed Gondola Transport System

(71) Applicant: Nicholas Patrick Caputo, Los Angeles, CA (US)

(72) Inventor: Nicholas Patrick Caputo, Los Angeles, CA (US)

(21) Appl. No.: 18/437,395

(22) Filed: Feb. 9, 2024

Related U.S. Application Data
(60) Provisional application No. 63/484,122, filed on Feb. 9, 2023.

(51) Int. Cl. B61B 7/06; B60L 7/10; B60L 8/00; B60L 13/00; B61B 12/00

(52) U.S. Cl. CPC B61B 7/06; B60L 7/10; B60L 8/003; B60L 13/006; B61B 12/002; B60L 2200/26; B60L 2220/16

(57) ABSTRACT

The disclosure relates to a transportation system for urban mass transit that employs an array of narrow, elevated towers supporting stationary electrified cables. Self-propelled gondolas equipped with electric motors and regenerative braking systems traverse these cables, transporting passengers between various ground-level stations. The gondolas are capable of attaching to and detaching from the cables via an automated mechanism controlled by an onboard computer. The system is modular, allowing for scalable adaptation to urban environments and incorporates solar panels for energy generation. The system's design minimizes urban land use, offering an environmentally conscious alternative to traditional mass transit systems.

### FIELD OF INVENTION

The present invention relates generally to the field of transportation engineering, specifically to an elevated gondola system for urban mass transit. It relates to the design and operation of cable-propelled transit systems that utilize self-propelled gondolas for passenger transportation in urban environments, and a corresponding system for monitoring of gondola cars location, environment, and health of the overall system, including towers which hold up the gondola cars.

### BACKGROUND

In the field of urban mass transit, the quest for efficient, cost-effective, and environmentally friendly transportation solutions has been a long-standing challenge which has become prohibitively expensive to construct and maintain in modern times. Traditional transportation systems, such as buses and subways, often struggle to balance the demands of high passenger volumes with the constraints of urban infrastructure traffic congestion. Buses, while flexible, contribute to said congestion and air pollution. Subways, on the other hand, offer high capacity and speed but require extensive and costly infrastructure development, including tunneling and large station footprints on land area which only becomes denser and more expensive over time. Such systems, often invented in the 19th and early 20th centuries, do not adequately provide meaningful solutions today in regards to their sheer cost, environmental impact, and time to construct. Alternative systems, such as monorails, suffer from drawbacks that hinder their usability in a mass transit setting, such as the inability to change routes when needed, to reduced passenger capacity versus trains and buses, to the lack of a safe method of disembarking in the event of a sudden loss of power.

The limitations of current systems are particularly evident in densely populated urban areas. Here, the need for high-capacity transit solutions clashes with the limited availability of land and the desire to preserve urban aesthetics. The construction of subway systems in such environments is not only prohibitively expensive due to the need for extensive excavation but also disruptive to existing cityscapes and communities. Additionally, the environmental impact of constructing and operating these systems is a growing concern, with significant usage of concrete and steel, contributing to a substantial carbon footprint.

Moreover, the operational efficiency of existing transit systems is often hampered by their reliance on outdated technologies such as heavy rail, which is prohibitively expensive to certain municipalities and campuses, presents a host of safety issues at train stations, and oftentimes requires installation at depths greater than 100 feet underground, with an example as of the time of this writing being the Grand Av/Bunker Hill Station along the Los Angeles Metro. Options such as street-level light rail also contain a host of issues, such as the risk of hitting automobiles or pedestrians. Elevated rail requires perpetual maintenance to maintain significant concrete or steel frames. Additionally, many systems suffer from high energy consumption and lack modern energy recovery mechanisms, such as regenerative braking. The integration of renewable energy sources is also a challenge, as existing infrastructure may not readily support such upgrades due to requirements that all future equipment support legacy voltage, track gauge and power requirements, for example.

Existing infrastructure, beyond its inefficiency in materials and electricity consumption, also presents logistical challenges with how deep underground it often needs to be installed. Oftentimes depths of over 100 feet are required to prevent collision with underground infrastructure that did not exist, and therefore was not a consideration, at the time technologies such as mass transit heavy rail was created. This presents a further problem to passengers who may be disabled, requiring traversal of significant flights of stairs, or the use of mass-traffic elevators, and to those who are healthy, but would be physically taxed through such a climb back up to street level. There are also inherent problems with building a tunnel or station at such depths underneath urban environments, such as the need to build stations to over 100,000 square feet in many instances to stabilize underground facilities, and the increased energy required to drill tunnels of adequate width while accounting for high geologic pressure at such depths. This further increases their time and expense to complete and operate.

Additionally, existing systems present significant challenges to maintain as they age. As anything built underground is inherently dependent on adequate stability of where it is constructed, existing transit systems are beleaguered by a host of issues. Examples are when ground is weakened due to excavation in a future development, underground aquifers that may be present are drained, extreme weather events occur that may cause flooding, and long term wear and tear along concrete tunnels may require intense efforts to patch and keep in adequate condition for public use.

Some gondola systems have been proposed in the past to address these challenges. However existing gondola systems, while offering some advantages in urban settings, have several inherent limitations that restrict their broader application in mass transit. These systems typically involve gondolas suspended from continuously moving cables, which limit their speed and capacity. The speed constraint arises from the continuous loop operation of the cables, which necessitates moderate speeds for safe boarding and alighting of passengers. This design inherently limits the throughput of the system, making it less suitable for the high-capacity demands of urban mass transit.

Furthermore, traditional gondola systems require significant space for both stations and tower structures. The stations, in particular, need to accommodate the mechanisms for the moving cables, resulting in larger footprints that can be challenging to integrate into dense urban environments. This spatial requirement often leads to the underutilization of gondolas in cities, where space is at a premium. Additionally, the visual impact of these systems, with their prominent cables and towers, can be a concern in urban settings where preserving the aesthetic integrity of the cityscape is important.

The energy efficiency of conventional gondola systems also presents a challenge. Most existing systems do not utilize regenerative braking, missing an opportunity to capture and reuse energy. The lack of integration with renewable energy sources further limits their sustainability. Moreover, the maintenance of these systems, particularly the moving cables which are prone to wear and tear, adds to the operational costs and can lead to more frequent service disruptions.

It is within this context that the present invention is provided.

### SUMMARY

The present invention relates to a transportation system designed to provide an elevated transit solution for urban environments. The system primarily consists of a plurality of narrow towers, each extending vertically, and at least two sets of electrified cables that connect them. These cables span between the towers, and a series of gondolas move individually along these cables. Ground-level stations facilitate the entry and exit of passengers, while the gondolas, each equipped with an electric motor and a regenerative braking system, transport passengers between these stations.

In some embodiments, the system is capable of being built modularly, wherein the cabling, stations, cars and towers are all separate pieces that can be replaced, removed or added on at any time. Cabling would extend from one point to another point, such as from a station to the first tower along the route path, or from one tower to another tower along the route path, and terminate. A separate cable would then begin, and the gondola car would transfer from one cable to the next. This allows routes to be expanded with relative ease, as well as parts in need of repair to be replaced without causing major service interruptions elsewhere in the network.

In some embodiments, the transportation system includes either monocrystalline or polycrystalline solar panels. This feature harnesses renewable energy, contributing to the system's sustainable operation. The modular design of the towers and stations enhances the system's scalability and simplifies installation within the constraints of urban landscapes.

In certain embodiments, each gondola is powered by one or many brushless DC electric motors encased in the housing above the cabin. The motors are strategically positioned at the top of the gondolas to directly engage with the electrified cables and ensure even weight distribution, which may improve operational stability.

In some embodiments, the gondolas incorporate a regenerative braking system by allowing the brushless DC electric motor, or set of motors, to be turned in the opposite direction as they normally run to propel the gondola down the cable. This system is designed to recapture kinetic energy during the process of deceleration and descending to ground level, contributing to the overall energy efficiency of the transportation system.

In some embodiments, the housing that contains the brushless DC electric motor, or set of motors, is attached to a hinge that connects it to the cabin of the gondola. This allows the housing to change angle as the cabling path causes the gondola to ascend or descend in height, while keeping the gondola cabin roughly level for passenger comfort.

In another embodiment, the gondolas are equipped with a cable attachment and detachment mechanism. This is accomplished by allowing the brushless DC electric motors to gently move laterally inside their housing. By doing so, they can continue operating until they reach the end of one cable, and attach to a new cable that is directly in front of it. The wheels that are turned by the electric motor are wider than the cable itself, allowing the gondola car to connect to the next cable in series, even if it is not perfectly lined up with the cable it is leaving behind. This allows for interoperability with cables of different gauges along the same track, and for compatibility with sets of cables that are not perfectly aligned.

In some embodiments, the gondola cars feature automated locking and release capabilities via application of downward pressure onto the cable. The housing above the cabin has the ability to increase tensile pressure on the cabling, creating a braking effect. These can be managed by the gondola's onboard computer or by an operator, allowing for smooth transitions and enhanced safety measures.

In some embodiments, the electrified cables are composed of a core of galvanized steel strands enveloped in a conductive layer. This construction provides the cables with the necessary tensile strength and electrical conductivity to support and power the gondolas.

In certain embodiments, the system's towers are designed with variable heights. This variability allows the system to adapt to different urban, suburban or rural terrains and maintain appropriate clearance above existing structures.

In some embodiments, user interface technologies are installed within the gondola cabins. These technologies present passengers with real-time travel information, route maps, and schedules, enhancing the user experience.

In some embodiments, the gondola cars hold glass which can be made transparent or opaque electronically via panes of glass which support adjustable window opacity. This is performed either via onboard control for passengers, remotely from a control center for the gondolas in the network, or automatically. This is to address potential acrophobia or agoraphobia in some passengers, and to provide privacy to homes and businesses which may have gondola cars pass close to their structures.

In a further embodiment, the control of the gondolas is managed by a hierarchical control system. This system can include a central command center, regional control units, and local control nodes at each station, which work in concert to manage the flow and operation of the gondolas throughout the network.

In some embodiments, the exterior of each gondola car is comprised of a metal frame, either built out of steel or a metallic alloy, allowing for rigidity, impact resistance, lack of electrical conductivity and light weight.

In some embodiments, the exterior of each gondola car includes windows that are made of FRA Type II laminated glass, which allows for transparency to the outside while also being resistant to impact, shattering and most natural damage and deterioration. They also provide the user the ability to see the world around them from unique vantage points.

In some embodiments, there are connecting wheels inside the housing above the gondola cabin that physically touch the cable, drawing electricity from it and providing a power source for the gondola.

### BRIEF DESCRIPTION OF THE DRAWINGS

Various embodiments of the invention are disclosed in the following detailed description and accompanying drawings.

FIG. 1 illustrates an isometric view of a gondola integral to the high-speed gondola transport system, highlighting its design for urban mass transit.

FIG. 2 depicts a segment of the transport system, showing several gondolas at a station, intermediate and full-height towers supporting electrified cables, with support for the integration of solar panels.

FIG. 3 shows an isometric view of a tower used within the system, detailing its narrow structure, support for electrified cables, solar panels, and smog sequestration units.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DESCRIPTION OF DRAWINGS

The present invention relates to a transportation system, specifically designed for urban mass transit. This system is characterized by the use of a series of narrow towers extending vertically to predetermined heights, supporting at least two sets of stationary electrified cables. These cables facilitate the movement of a plurality of gondolas, each equipped with at least one electric motor and a regenerative braking system, held inside a housing above the gondola's cabin that surrounds the section of cable that the gondola is attached to. The gondolas are designed to move in a group or individually along the cables that are elevated above existing structures between various ground-level stations, providing transit services for passengers in urban environments. A given station has cabling that is sufficiently low to the ground to allow gondola cars to be boarded and disembarked by passengers near ground level. Once leaving the station, cabling will begin ascending to a predetermined height above the ground by being attached to a nearby tower of that same height. It will then transit over existing structures on the ground, allowing for smooth and efficient transit. The cabling that the gondola will traverse at this height will be supported by at least one, but possibly multiple, additional towers. When nearing a new station, the cabling from the nearest tower to that station will descend to the height of that station. The gondola, in turn, will then descend to the height of the aforementioned station and be able to safely open the doors on the gondola cabin to allow embarking and alighting of passengers. The gondola will then ascend upwards to another tower if there is more track to continue traveling on, or may remain at ground level if its current station is a terminus.

The housing above the gondola cabins contains one or more electric motors which can propel the gondola along the cabling. It also contains spring mechanisms and shock absorbers which allow for sudden lateral or unexpected movements to be dampened, ensuring a smooth transit experience. It also contains mechanisms to apply pressure to the cable that it is on, causing braking and, optionally, the eventual cessation of motion of the gondola car. Additionally, the housing contains electric wiring allowing for the transmission of electricity from the cables to the machinery inside the gondola. Additionally, the housing is sufficiently long, encasing a length of cabling is captured that prevents gondola cars from making a rocking motion laterally. Additionally, the housing is sufficiently long to prevent a collision of gondola cabins in the event that two cars come close to each other. Additionally, the tensile strength of the cabling, and of the frame of the gondola cars, will allow for a maximum weight limit per gondola car that far exceeds what passengers would be able to weigh combined. Additionally, the housing above the cabin contains a measuring device that allows the gondola car to report its weight at any given time, allowing for transfer of people or prevention of operation if a predetermined weight limit is nevertheless exceeded.

The electric motor mounted in each gondola is configured to propel the gondola along the electrified cables, while the regenerative braking system contributes to the energy efficiency of the transportation method. The system further comprises at least one control center responsible for orchestrating the movement of the gondolas, ensuring they travel in train-like formations along the cables, and managing the boarding and alighting of passengers at the stations.

Additionally, the transportation system includes solar panels integrated into the towers and ground-level stations, contributing to the generation of renewable energy. The towers and stations are designed with modular construction, enhancing the scalability of the system and easing its installation in dense urban areas.

The gondolas are outfitted with brushless DC electric motors for propulsion, positioned at the top of the gondolas to ensure direct engagement with the electrified cables and even distribution of weight. The gondolas also feature a cable attachment and detachment mechanism, furnished with automated locking and release features controllable by the gondola's onboard computer.

The electrified cables in the system are composed of a core of galvanized steel strands wrapped in a conductive layer. The system's towers are varied in height, ranging from 50 to 100 meters, to accommodate different urban landscapes and ensure clearance above buildings.

User interface technologies are included within the gondolas, offering passengers real-time travel information, route maps, and schedules. The control center of the system utilizes a hierarchical control structure, comprising a central command center, regional control units, and local control nodes at each station to manage the operation of the gondolas.

FIG. 1 provides an isometric view of a gondola 100, integral to a high-speed gondola transport system for urban mass transit. The gondola 100 is constructed with a frame 102 made from lightweight, high-strength materials such as for example aluminum, incorporating windows of tempered glass or polycarbonate. The frame 102 is engineered to support a range of dimensions, for example a length of 10-15 meters, a width of 2-3 meters, and a height of 2.5-3.5 meters, to accommodate varying passenger capacities. A door 104 facilitates passenger ingress and egress.

Mounted atop the gondola 100 is a detachable coupling 106, which is connected to a support 108. The support 108 is in turn coupled to a pair of suspension couplings 110, which house pulleys 112. These pulleys 112 are propelled along a pair of electrified cables 116 by an electric motor drive 114, for example a brushless DC electric motor. This motor, with a power rating ranging from for example 50 to 100 kilowatts, is positioned to engage directly with the electrified cables 116, ensuring optimal power application and weight distribution for the gondola's propulsion.

The electrified cables 116 may for example have a core of galvanized steel strands, covered in a conductive layer, such as copper or aluminum, to facilitate electrical transmission. The cables are designed to withstand significant environmental stress, with an example diameter range of 50-75 mm and an example tensile strength of 1,000-1,500 MPa. A continuous electrification system with segmented sections maintains power delivery to the gondola 100 while accommodating its movement along the cables.

The gondola 100 utilizes a regenerative braking system capable of capturing kinetic energy during deceleration, with an energy recapture efficiency of 70-80%. This system not only improves energy efficiency but also contributes to the system's reduced environmental impact. Additionally, the gondola features an attachment and detachment mechanism with automated locking and release features, controlled by the gondola's onboard computer, and emergency release procedures that can be activated manually or automatically.

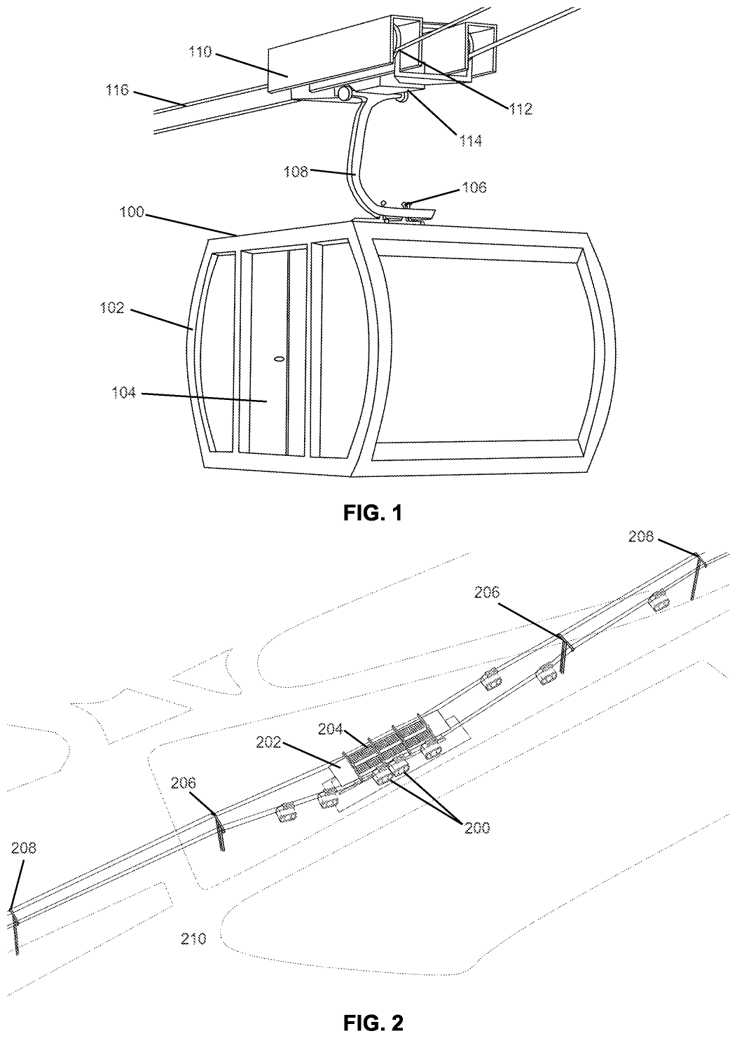

FIG. 2 depicts a segment of the high-speed gondola transport system, illustrating several gondolas 200 stationed at a transport station 202. These gondolas 200 are part of a transit system that facilitates urban mass transit by moving individually along electrified cables 210. The station 202 is equipped with a platform that allows passengers to embark and disembark from the gondolas 200. Above the platform, solar panels are integrated into the station's design, providing a renewable energy source for the system's operations.

Adjacent to the station 202, intermediate height towers 206 are positioned to support the electrified cables 210. The cables extend from these intermediate towers 206 to full height towers 208, demonstrating the system's vertical integration capability within an urban landscape. The dashed lines representing urban scenery indicate the system's ability to operate in densely populated areas without significant alteration to the existing environment.

The gondolas 200 are designed to move along the stationary electrified cables 210, propelled by electric motors. These motors are configured to allow the gondolas to travel at speeds of up to 50 mph.

The towers 206, 208 exhibit a range of heights to adapt to varied urban terrains, providing clearance above existing structures. These towers can be equipped with smog sequestration technology and energy storage systems like lithium-ion batteries or supercapacitors to further enhance the system's sustainability. User interface technologies within the gondolas offer real-time travel information, and a comprehensive sensor network monitors the system's performance.

A central command center, along with regional control units and local control nodes, may form a hierarchical control structure to manage the gondolas' operation. The system's communication infrastructure, traffic management software, and automated diagnostics are integral to its efficient function.

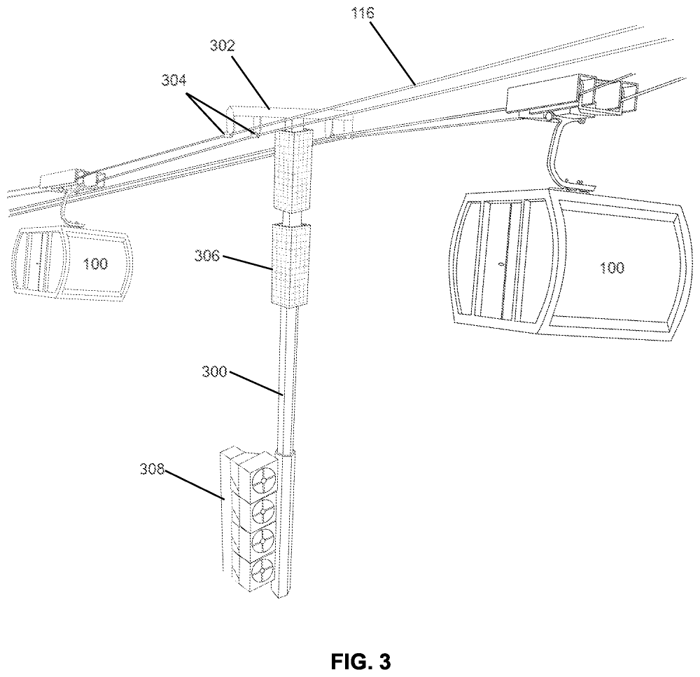

FIG. 3 illustrates an isometric view of a tower 300 utilized within the high-speed gondola transport system. The tower 300 features a narrow central support designed to minimize land use and is constructed with materials that provide the necessary structural integrity while reducing the usage of concrete and steel.

Atop the central support of the tower 300, a pair of horizontal arms 302 extend outward. Each arm 302 is equipped with a pair of hooks 304, which are configured to secure and maintain the position of the electrified cables 116. These cables 116 are integral to the system, providing the route along which the gondolas 100 are propelled by their onboard electric motors.

Adjacent to the horizontal arms 302 and affixed near the top of the tower 300, there are solar panel units 306. These units 306 are integrated into the tower's design to harness solar energy, contributing to the power needs of the transport system and enhancing its sustainability.

Mounted near the base of the tower 300 is a set of smog sequestration units 308. These units 308 are designed to capture pollutants from the air, improving the environmental footprint of the transit system and contributing to cleaner urban air quality.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “gondola” refers to any passenger-carrying unit capable of moving along a set of cables. Such a gondola may include, but is not limited to, enclosed cabins, open cabins, chairs, or any other structures designed to transport individuals or groups of passengers. The gondola may vary in size, shape, and capacity, and may be equipped with seating, standing room, or provisions for transporting bicycles or other personal belongings.

The term “electrified cable” as described herein encompasses any cable or wire capable of conducting electricity to power the movement of gondolas. This may include, but is not limited to, cables made from steel, copper, aluminum, or any other conductive materials, or combinations thereof. The cables may be insulated, semi-insulated, or uninsulated and may be singular, stranded, or bundled.

As used herein, “stationary” in reference to the electrified cables means that the cables do not move along with the gondolas. However, this does not preclude the cables from being capable of slight movements, such as swaying or other movements due to environmental factors, so long as the primary mode of gondola propulsion does not result from the movement of the cables themselves.

The term “tower” as used herein refers to any vertical structure supporting the electrified cables for the gondola system. Towers may be of any height, material, or configuration and may include additional features such as solar panels, communications equipment, lighting, or other utility functions. The term encompasses monopoles, lattice structures, pylons, masts, or any other structures that provide the required elevation and support for the cables.

The phrase “ground-level station” refers to any passenger interface for boarding or alighting from the gondolas. Such stations may be located at, above, or slightly below the surface level and can include platforms, buildings, enclosures, or any other structures facilitating passenger transfer to and from the gondolas. Ground-level stations may also include amenities such as ticketing services, waiting areas, information kiosks, restrooms, or commercial establishments.

The term “control center” as used herein refers to any facility or system responsible for the operational management of the gondola transportation system. This includes, but is not limited to, physical control rooms, distributed control systems, or virtual management platforms. The control center may employ a variety of technologies for monitoring, directing, and coordinating the movement of gondolas, including computer hardware, software, communication systems, and data processing equipment. The control center's functionalities may encompass traffic management, safety monitoring, emergency response coordination, and integration with other urban transportation systems. Additionally, the term “control mechanisms” within this context refers to the hardware, software, and protocols used for the direct control of the gondolas' movement, speed, boarding, and alighting processes, and maintenance operations. This can include, but is not limited to, automated systems, manual override options, remote control capabilities, and predictive analytics tools.

The term “regenerative braking system” as described herein includes any mechanism or technology capable of capturing kinetic energy from the gondolas when slowing down or stopping and converting this energy into electrical energy. This may involve various forms of technology including, but not limited to, electromagnetic, electrostatic, or mechanical energy storage systems.

“Modular construction” as used herein refers to a construction method where the system's components are prefabricated and designed for quick assembly and disassembly. This may include standardized units or sections that can be easily transported and configured to suit different urban environments and operational needs.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the transport system and its structure have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A transportation system comprising:
a plurality of narrow towers, each tower extending vertically to a predetermined height;
at least two sets of electrified cables, each cable being stationary and extending between at least two of the plurality of towers;
a plurality of ground-level stations; and
a plurality of gondolas, each gondola being configured to move individually along one set of the electrified cables and comprising:
an electric motor mounted in each of the plurality of gondolas, wherein the electric motor is configured to propel the gondola along the pair of electrified cables; and
a regenerative braking system incorporated in each of the plurality of gondolas;
wherein the system further comprises at least one control center configured to cause the gondolas to move between the stations in grouped formations along the sets of electrified cables and to facilitate the boarding and alighting of passengers from the gondolas.

2. The transportation system of claim 1, further comprising solar panels integrated into the towers and ground-level stations for generating renewable energy.

3. The transportation system of claim 1, wherein the towers and ground-level stations are designed with modular construction for scalability and ease of installation in dense urban areas.

4. The transportation system of claim 1, wherein each gondola comprises a brushless DC electric motor for propulsion.

5. The transportation system of claim 1, wherein the electric motors are positioned at the top of the gondolas for direct engagement with the electrified cables and to distribute weight evenly.

6. The transportation system of claim 1, wherein the gondolas employ a regenerative braking system capable of recapturing kinetic energy during deceleration.

7. The transportation system of claim 1, wherein each gondola comprises a cable attachment and detachment mechanism.

8. The transportation system of claim 7, wherein the cable attachment and detachment mechanism is provided with automated locking and release features controllable by the gondola's onboard computer.

9. The transportation system of claim 1, wherein the electrified cables comprise a core of galvanized steel strands wrapped in a conductive layer.

10. The transportation system of claim 1, wherein the towers have height variations ranging from 50-100 meters to accommodate varying urban landscapes and provide clearance above buildings.

11. The transportation system of claim 1, further comprising user interface technologies within the gondolas for providing passengers with real-time travel information, route maps, and schedules.

12. The transportation system of claim 1, wherein the at least one control centre comprises a hierarchical control structure with a central command center, regional control units, and local control nodes at each station for managing the operation of the gondolas.
